(19) United States
(12) Patent Application Publication
(10) Pub. No.: US 2009/0119640 A1
(43) Pub. Date: May 7, 2009

(54) GRAPHICAL APPLICATION FOR BUILDING DISTRIBUTED APPLICATIONS

(75) Inventors: William D. Ramsey, Redmond, WA (US); Ronnie I. Chaiken, Woodinville, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/936,105

(22) Filed: Nov. 7, 2007

(51) Int. Cl. G06F 9/44

(52) U.S. Cl. 717/109

(57) ABSTRACT

A graphical application development tool for developing parallel computation applications. The tool facilitates insertion of computational elements by a drag-and-drop operation onto a canvas area for creating a computational graph. The graphical application tool reduces the barriers to the development of parallel computation applications by entry-level developers, for example, by allowing these users to write applications by using a graphical tool, thereby avoiding complexities of having to write well-formed code and learning a new language. The tool includes built-in functionality that allows the developer to write arbitrary code (e.g., C#) to perform various functions on massive amounts of data.

### BACKGROUND

Processing increasingly large amounts of data is critical to the needs of companies that deliver products and services derived from literally billions of disparate data points. As data processing needs expand, the infrastructure to store, manage, and operate on the massive amounts of data must expand as well. A great deal of work has been done on fault-tolerant storage systems and a similar amount of work has been done on parallel-processing algorithms producing Directed Acyclic Graphs (DAGs) for purposes such as Distributed SQL systems and log-processing systems.

Distributed computing has been investigated for many years in distributed database work. Unlike running an operation on a single computer, a distributed computation cannot share memory between processes and a variety of strategies are used to make the computations more efficient or, in some cases, even possible. In general, there are a few common constructs used in distributed computations: partitioning the data into buckets (referred to as a “map” operation), aggregating parallel outputs, processing data in parallel, and joining two parallel outputs.

Creating distributed applications is challenging for several reasons. It is difficult to master the distributed computing concepts listed above and once the programmer masters enough of the concepts applying those concepts to some actual code is difficult. Moreover, it is difficult to write the code because developers completely sure how the code will be called, how each step leads into another, and many of the same functions are written from scratch.

Despite the huge amount of work, it is still difficult for developers and researchers to write applications to take advantage of the huge computational advantages of running computations on a cluster.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Disclosed is a graphical application development tool for developing parallel computation applications by dragging-and-dropping computational elements onto a canvas. The graphical application tool reduces the barriers to the development of parallel computation applications by entry-level developers, for example, by allowing these users to write applications by using a graphical tool, thereby avoiding complexities of having to write well-formed code and learning a new language. The tool includes built-in functionality that allows the developer to write arbitrary code (e.g., C#), for example, to perform various functions on massive amounts of data.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a computer-implemented graphical programming system.

FIG. 2 illustrates a system that employs a development system for creating massively parallel applications to be run on a computer cluster.

FIG. 3 illustrates an exemplary development builder interface for drag-and-drop functionality and signature presentation.

FIG. 4 illustrates an exemplary development builder interface for drag-and-drop functionality and presentation of information associated with a SQL node.

FIG. 5 illustrates an exemplary development builder interface showing a node where multiple library functions satisfying the semantics of a Process node are shown.

FIG. 6 illustrates an exemplary development viewer interface showing a compiled computation graph from the Joined graph of FIG. 3.

FIG. 7 illustrates an exemplary development viewer interface showing a compiled graph of the SQL statement for the graph of FIG. 4.

FIG. 8 illustrates a method of developing a massively parallel application.

FIG. 9 illustrates a method of providing user interaction in a graphical programming environment for massively parallel application generation.

FIG. 10 illustrates a method of employing SQL syntax in a graphical programming environment for massively parallel application generation.

FIG. 11 illustrates a block diagram of a computing system operable to execute the disclosed graphical programming tool for creating a computation application to run on a cluster computing architecture.

### DETAILED DESCRIPTION

A graphical application development tool is provided for developing parallel computation applications. The graphical application tool reduces the barriers to the development of parallel computation applications by entry-level developers, for example, by allowing these users to write applications by using a graphical tool by dragging-and-dropping computational elements into a canvas area. When inserted into the canvas area, an element is represented as a node in the creation of a computation graph. Multiple processes across a computing cluster can be processed together to provide the desired output thereby avoiding complexities of having to write well-formed code and learning a new language.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

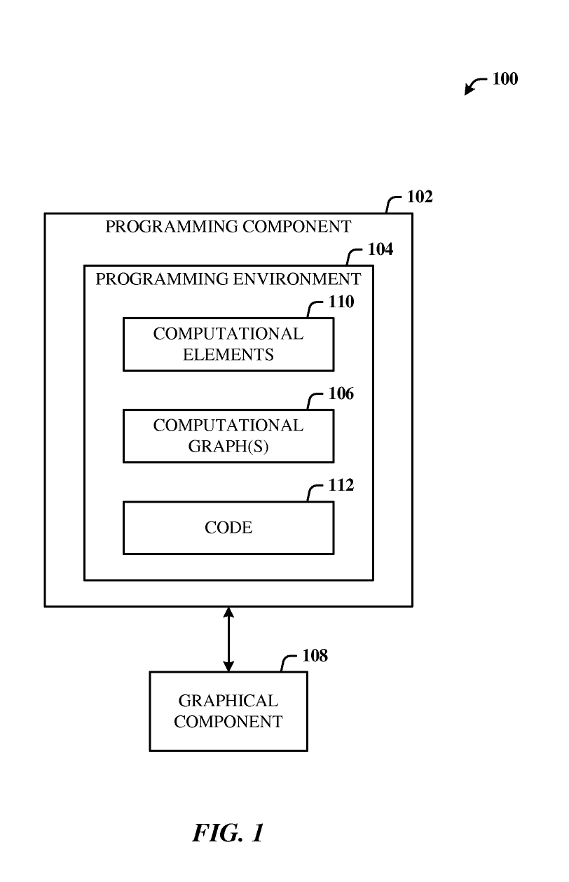

FIG. 1 illustrates a computer-implemented graphical programming system 100. The system 100 includes a programming component 102 for providing a programming environment 104 in which a computational graph 106 can be generated and applied to a computing cluster. A graphical component 108 provides at least drag-and-drop functionality in the programming environment 104 to create the computational graph 106. The graphical component 108 also facilitates the presentation of computational elements 110 and code 112 related to distributed computing abstractions of a managed library. The computational elements 110 represent built-in functions each having a specific signature. This will be illustrated herein after. The graphical component 108 presents a signature associated with a graph node of the computational graph 106 in response to selection of the graph node in the computational graph.

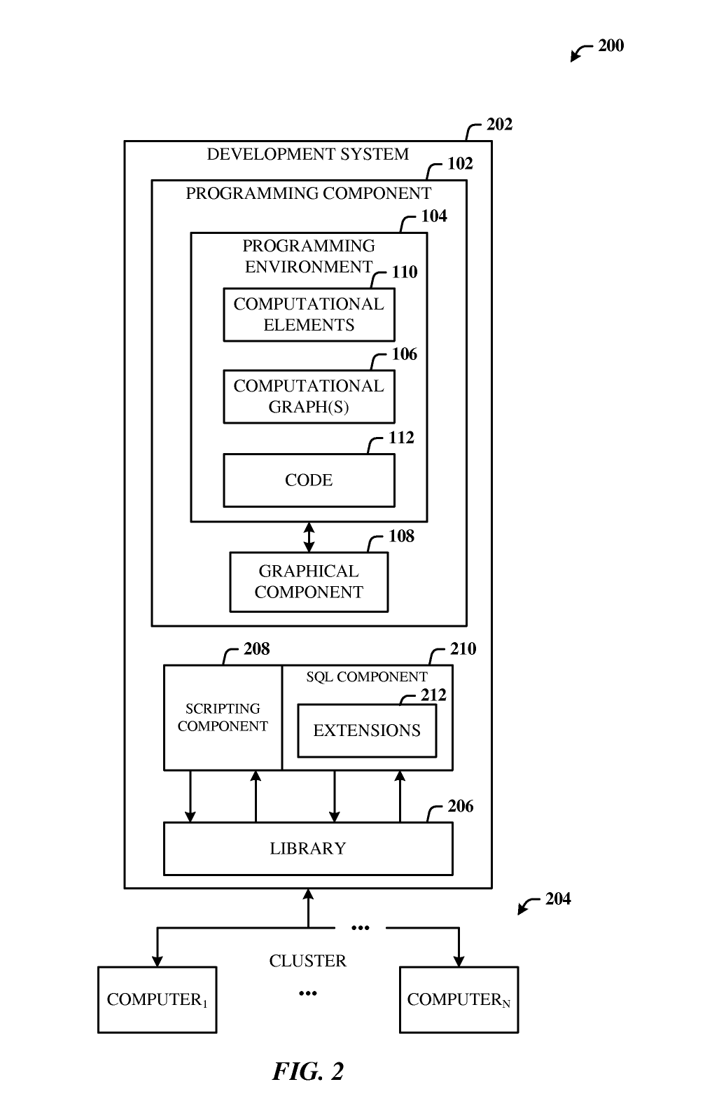

FIG. 2 illustrates a system 200 that employs a development system 202 for creating massively parallel applications to be run on a computer cluster 204. The development system 202 includes the programming component 102 for providing the program environment 104, and the graphical component 108, here, depicted as part of the programming component 104. The programming environment 104 facilitates the presentation of the computation graph 106, computational elements for creating the graph 106, and the code 112 associated with nodes of the graph 106.

The development system 202 can also include a library 206 of functions that can be accessed by a scripting component 208 for writing scripts that employ built-in functions of the library 206, and a SQL (structured query language) component 210 for writing and processing SQL statements that utilize extensions 212 (e.g., programming language extensions such as C#) the facilitate the use of the functions of the library 206. The extensions 212 can be provided via the SQL component 210. An output of the data processing system 202 is not only queries for execution against the cluster 204, but also the computational graphs 106 (e.g., Directed Acyclic Graph). The library 206 (e.g., written in C#) exposes various abstractions for building arbitrary computational graphs 106. The library 206 allows a developer to write functions (or delegates, in the C# world) that can be used in a variety of configurations to perform different computations. Using the library 206 (and associated framework), developers are able to write code that can be run on literally thousands of machines, as easily as it is to write code that runs on a single machine.

The data processing system 202 facilitates application development for running computations on the cluster 204. For the C# developer, for example, the library 206 abstracts out many of the distributed computing constructs and automatically configures itself to run on the computer cluster 204 or locally. The development system 202 can interface to the computer cluster 204 to run the compiled or interpreted computational graphs 106.

The SQL component 210 provides a textual layer similar to SQL syntax that calls into the library 206. This allows many computations such as obtaining data matching certain criteria. The SQL component 210 allows the developer to transform results, since the SQL component 210 can call into the library 206 directly. In addition, the SQL component 210 can co-exist with the scripting component 208 and allow the developer to write scripts and use the SQL component 210 to simplify the code (and amount of code) for performing an analysis. By facilitating programming language extensibility into the SQL syntax, developers are allowed to extend the range of what can be expressed within SQL statements. The library 206 allows developers to perform data analysis on large datasets (e.g., terabytes or larger) of the cluster 204 using scripts and SQL statements. The underling computation is then generated automatically.

The graphical component 108 allows entry and selection of a function, an argument for the function, and inputs, for example, and also presents a tailored view based on a selected node of the computational graph 106. The tailored view can include structure query language statement semantics. The graphical component 108 can also present multiple library functions of a node selected in the computational graph 106. The programming component 102 compiles code associated with the computational graph(s) 106 for application to the computer cluster 204.

As will be described herein, the graphical component 108 includes a user interface via which the drag-and-drop functionality, computational elements for creating the computational graph, creation state of the computational graph as presented on a canvas, code associated with nodes of the computational graph, and complied version of the computational graph, are exposed for interaction.

Following are a series of user interfaces that exemplify the capabilities of the disclosed graphical application development tool. The tool is a way that developers can quickly compose applications without having to learn a language or loading an alternative development studio, for example. The tool allows users/developers to drag-and-drop computational elements that have specific meaning in the associated development components (e.g., Process, Map, Sort, Aggregate, Join, Output, and SQL) onto a graphing canvas.

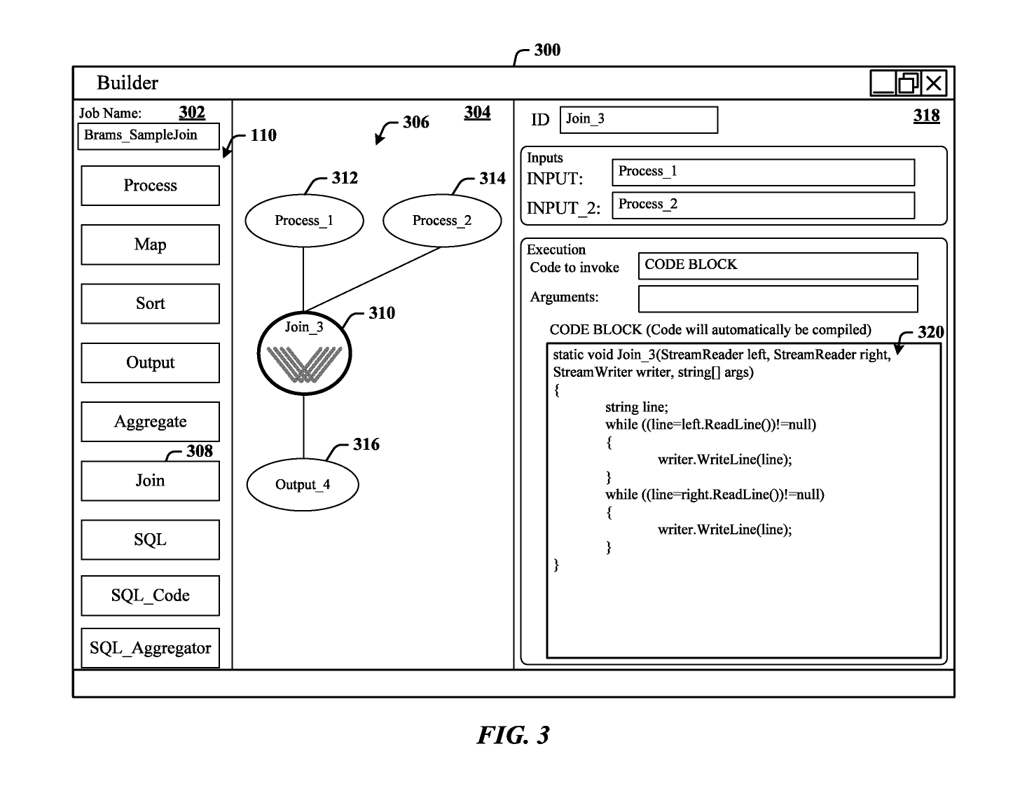

FIG. 3 illustrates an exemplary development builder interface 300 for drag-and-drop functionality and signature presentation. The interface 300 includes a section 302 that presents selectable computational elements 110 such as Process, Map, Sort, Output, Aggregate, Join, SQL, SQL_Code, and SQL_Aggregator. A canvas area 304 into which the user can drag-and-drop one of the computational elements 110 will immediately create a corresponding node of a computational graph 306 being created. For example, dragging-and-dropping a Join computational element 308 into the canvas area 304 will create a Join node 310. Here, the graph 306 of the computation created indicates that a Process_1 of a first process node 312 will operate on an input stream, a Process_2 of a second process node 314 will operate on a different input stream, the Join_3 operation associated with the Join node 310 will join the outputs from Process_1 and Process_2, and the output from Join_3 operation will feed into an Output node 316.

A right pane 318 allows the user to supply functions (e.g., C# code that is shown or point to a built-in library function), arguments to the functions, inputs, etc. Here, the Join node 310 is selected (or highlighted). In response, the right pane 318 shows an identifier (ID) of the Join node 310 (as Join_3), the input connections (e.g., Process_1 and Process_2), the name of the code to invoke (e.g., a built-in method or user-supplied code in the CODE_BLOCK), and the actual code 320 in the CODE BLOCK.

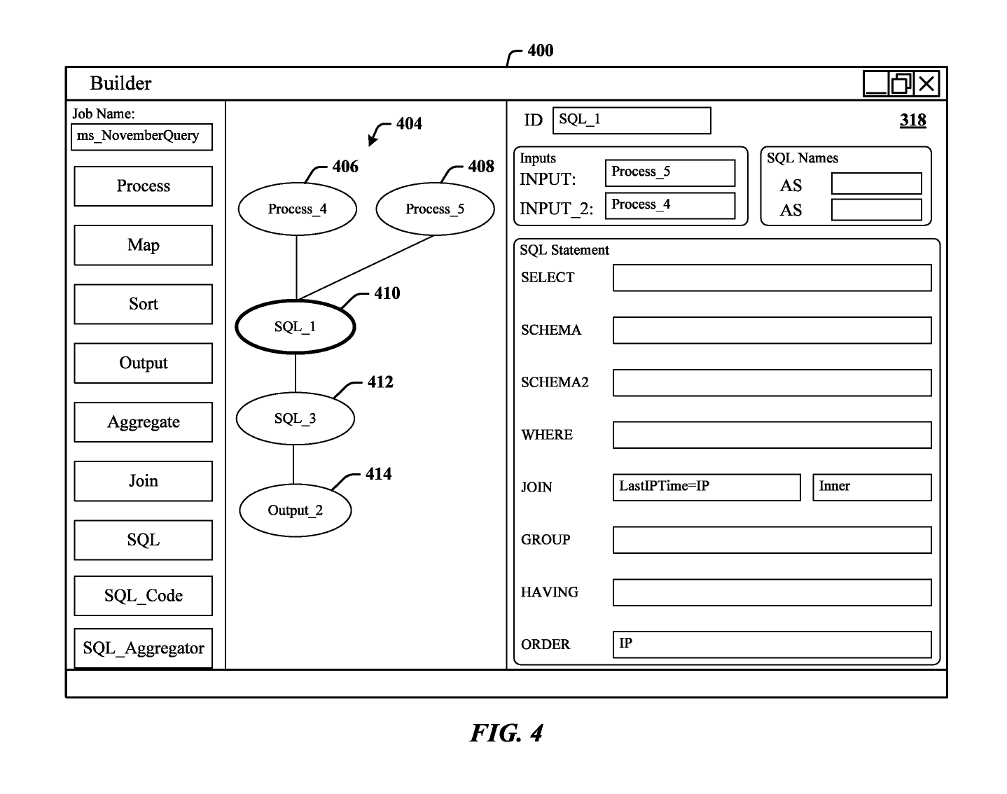

FIG. 4 illustrates an exemplary development builder interface 400 for drag-and-drop functionality and presentation of information associated with a SQL node 402. Here, a graph 404 of the computation created indicates that a Process_4 of a fourth process node 406 will operate on an input stream, a Process_5 of a fifth process node 408 will operate on a different input stream, a first SQL statement SQL_1 at a first SQL node 410 operates on the outputs from Process_4 and Process_5. A second SQL statement SQL 3 at a second SQL node 412 operates on the output from the first SQL node 410, and the output of the second SQL node 412 feeds into an Output node 414.

The first SQL node 410 is selected (and highlighted). In response, the right pane 318 shows a view that is tailored to the SQL component, and includes: Inputs (in this case the node is joining on two nodes' output), SELECT (what fields to select), SCHEMA (a description of each input's variable types), WHERE (filters on non-aggregated data), JOIN (condition to join on if there are two inputs), HAVING (filter on aggregated data), GROUP (fields to group on), and ORDER (fields to sort on).

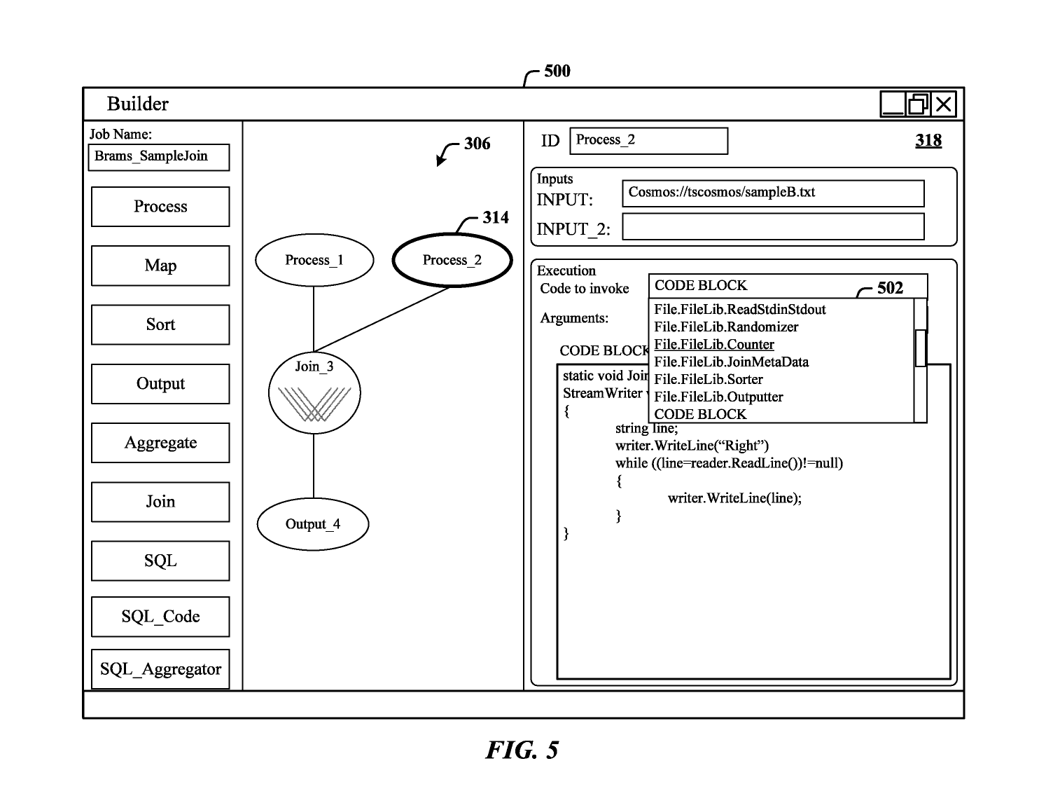

FIG. 5 illustrates an exemplary development builder interface 500 showing a node where multiple library functions satisfying the semantics of a Process node are shown. Here, the graph 306 of the computation created indicates that the Process_2 of the second process node 314 is selected (and highlighted). In response, in the right pane 318, multiple library functions satisfying the semantics of a Process node (e.g., a ProcessDelegate with signature {StreamReader, StreamWriter, string[ ]}) are shown in a drop-down menu 502.

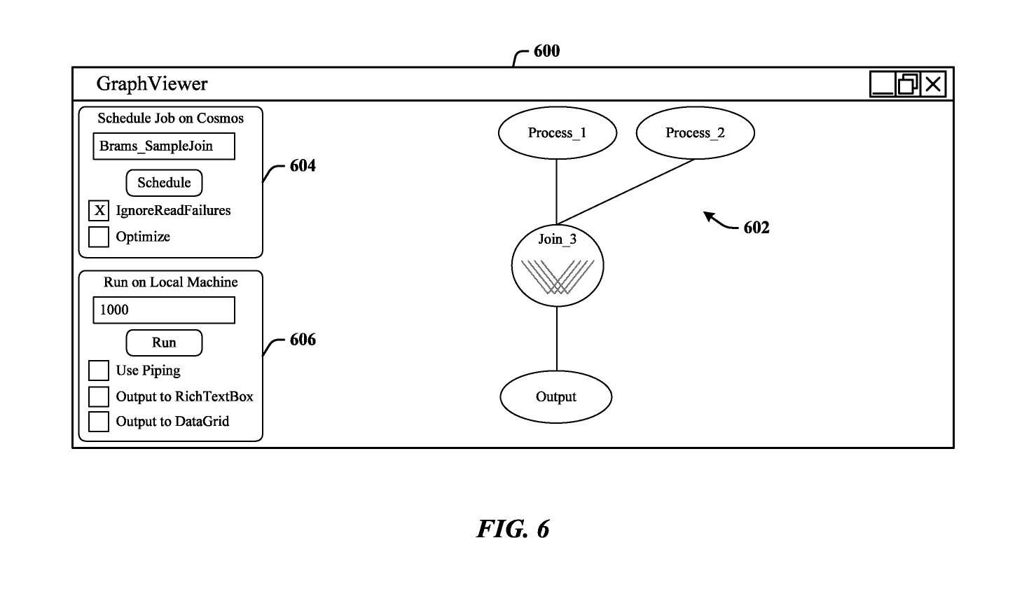

FIG. 6 illustrates an exemplary development viewer interface 600 showing a compiled computation graph 602 from the Joined graph 306 of FIG. 3. As previously indicated, an interpreter is used to build and deploy the application. The interpreter knows how to parse the generated file into Code Blocks and commands, strips out comments (e.g., a comment starts with “//” and is highlighted in s special way), and determines which of the overloaded functions to call. The interpreter is also responsible for making sure the Code Blocks (e.g., C#) are compiled into an executable file and that the executable file is handed off to the appropriate entity (e.g., the managed library 206).

The interface 600 also shows a job scheduler subpanel 604 and a local machine selector subpanel 606. The scheduler subpanel 604 provides a field into which the associated filename can be entered for scheduled execution. The local machine subpanel 606 allows the developer to select which machine (e.g., 1000) in the cluster to run the scheduled file.

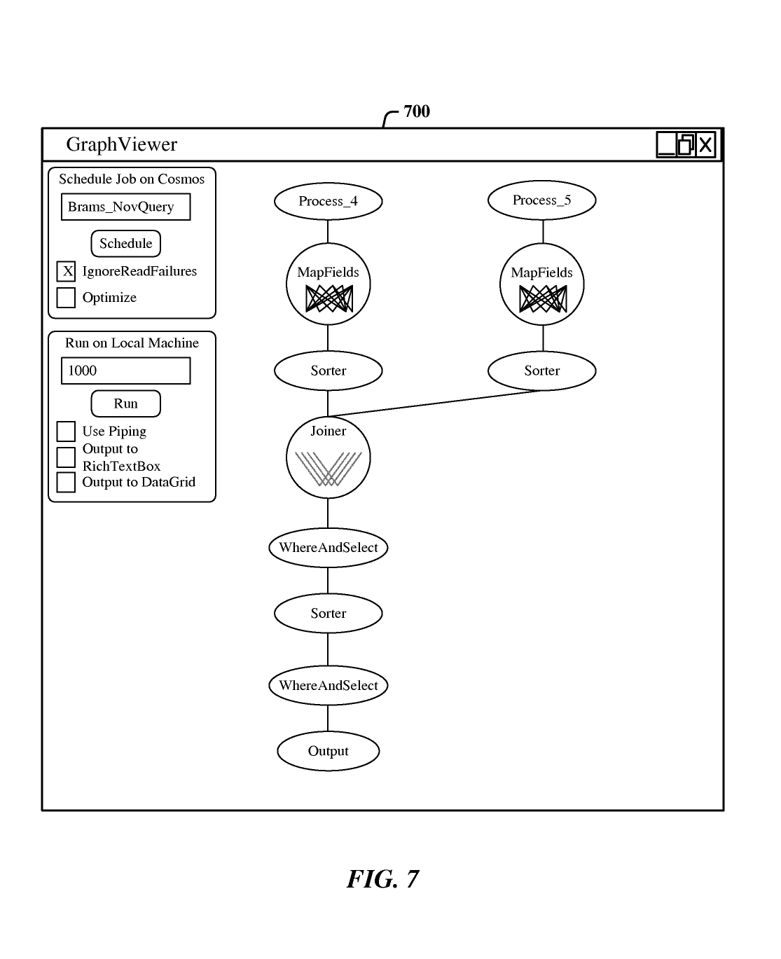

FIG. 7 illustrates an exemplary development viewer interface 700 showing a compiled graph 702 of the SQL statement for the graph 404 of FIG. 4.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

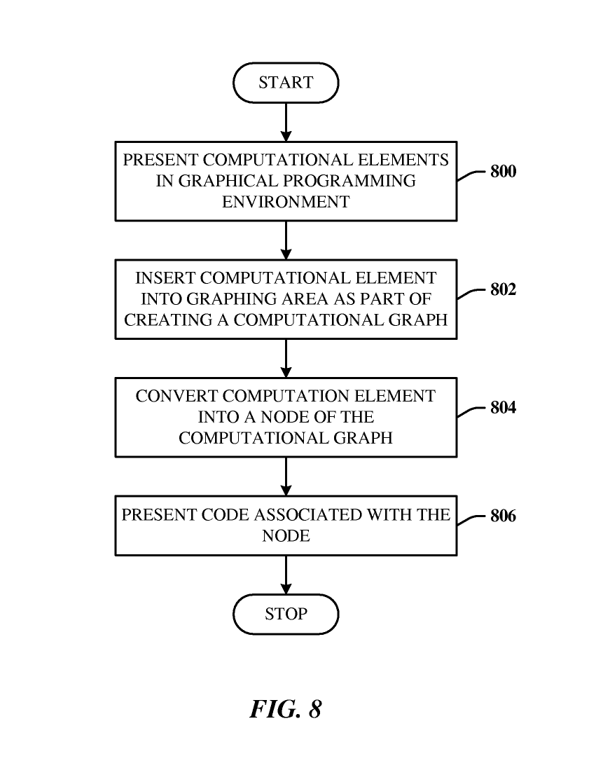

FIG. 8 illustrates a method of developing a massively parallel application. At 800, computational elements are presented in a graphical programming environment. At 802, a computational element is inserted into a graphing area as part of a creating a computational graph. At 804, the computation element is converted into a node of the computational graph. At 806, code associated with the node is presented.

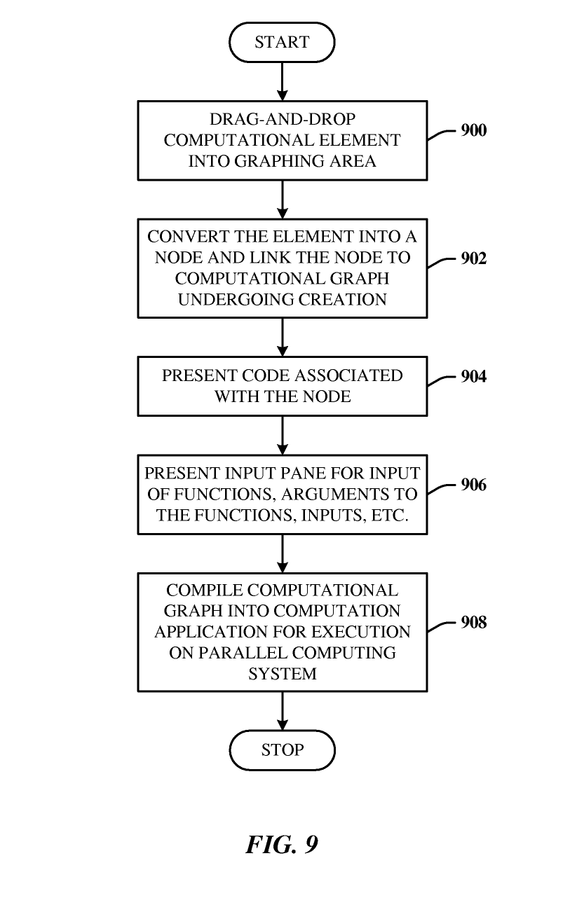

FIG. 9 illustrates a method of providing user interaction in a graphical programming environment for massively parallel application generation. At 900, a computational element is inserted into a graphing area via a drag-and-drop operation. At 902, the element is converted into a node, and the node is logically linked to a computational graph undergoing creation. At 904, code associated with the node is presented. At 906, an input pane is presented for the entry of a function, arguments to the function, inputs, etc. At 908, the graph can be compiled in a computation application for execution on a parallel computing system.

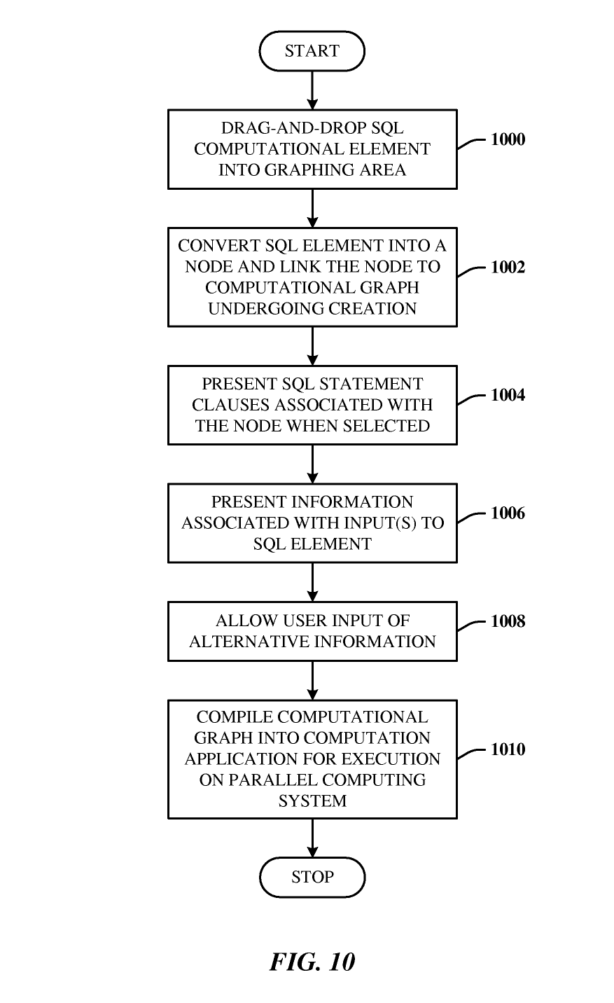

FIG. 10 illustrates a method of employing SQL syntax in a graphical programming environment for massively parallel application generation. At 1000, a SQL computational element is inserted into a graphing area via a drag-and-drop operation. At 1002, the SQL element is converted into a node, and the node is logically linked to a computational graph undergoing creation. At 1004, SQL statement clauses associated with the node are presented when the node is selected. The clauses can include Select, Schema, Where, Join, Group, Having, and Order, for example, or clauses that provide similar functionality. At 1006, information associated with inputs to the SQL element is presented. At 1008, a user is allowed to enter alternative information for an SQL clause. At 1010, the graph can be compiled in a computation application for execution on a parallel computing system.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

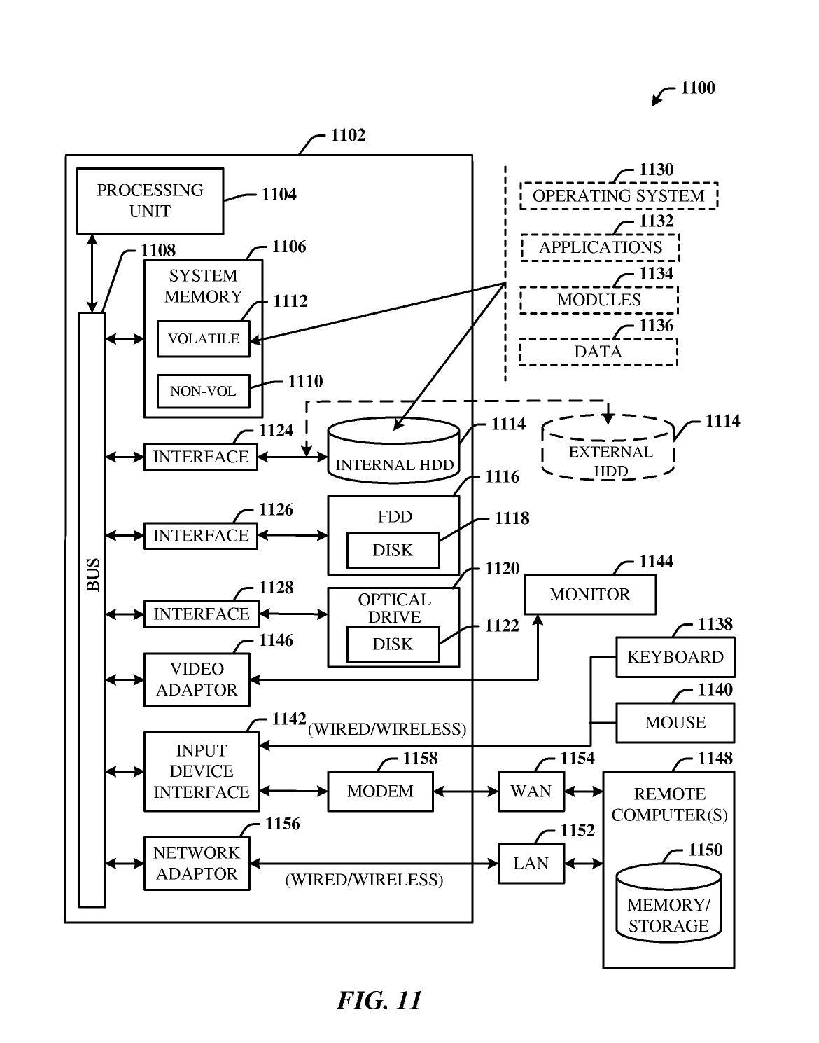

Referring now to FIG. 11, there is illustrated a block diagram of a computing system 1100 operable to execute the disclosed graphical programming tool for creating a computation application to run on a cluster computing architecture. In order to provide additional context for various aspects thereof, FIG. 11 and the following discussion are intended to provide a brief, general description of a suitable computing system 1100 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 11, the exemplary computing system 1100 for implementing various aspects includes a computer 1102 having a processing unit 1104, a system memory 1106 and a system bus 1108. The system bus 1108 provides an interface for system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 can include non-volatile memory (NON-VOL) 1110 and/or volatile memory 1112 (e.g., random access memory (RAM)). A basic input/output system (BIOS) can be stored in the non-volatile memory 1110 (e.g., ROM, EPROM, EEPROM, etc.), which BIOS stores the basic routines that help to transfer information between elements within the computer 1102, such as during start-up. The volatile memory 1112 can also include a high-speed RAM such as static RAM for caching data.

The computer 1102 further includes an internal hard disk drive (HDD) 1114 (e.g., EIDE, SATA), which internal HDD 1114 may also be configured for external use in a suitable chassis, a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as a DVD). The HDD 1114, FDD 1116 and optical disk drive 1120 can be connected to the system bus 1108 by a HDD interface 1124, an FDD interface 1126 and an optical drive interface 1128, respectively. The HDD interface 1124 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 1112, including an operating system 1130, one or more application programs 1132, other program modules 1134, and program data 1136. The one or more application programs 1132, other program modules 1134, and program data 1136 can include the programming component 102, programming environment 104, the computational elements 110, the computational graph(s) 106, the code 112, the graphical component 108, the development system 202, the scripting component 208, the SQL component 210, the extensions 212, the library 206, the builder interfaces (300, 400, and 500), the viewer interfaces (600 and 700), for example.

All or portions of the operating system, applications, modules, and/or data can also be cached in the volatile memory 1112. It is to be appreciated that the disclosed architecture can be implemented with various commercially available operating systems or combinations of operating systems.

A user can enter commands and information into the computer 1102 through one or more wire/wireless input devices, for example, a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces such as a parallel port, IEEE 1394 serial port, a game port, a USB port, an IR interface, etc.

A monitor 1144 or other type of display device is also connected to the system bus 1108 via an interface, such as a video adaptor 1146. In addition to the monitor 1144, a computer typically includes other peripheral output devices (not shown), such as speakers, printers, etc.

The computer 1102 may operate in a networked environment using logical connections via wire and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wire/wireless connectivity to a local area network (LAN) 1152 and/or larger networks, for example, a wide area network (WAN) 1154. Such LAN and WAN networking environments are commonplace in offices and companies, and facilitate enterprise-wide computer networks, such as intranets, all of which may connect to a global communications network, for example, the Internet.

When used in a LAN networking environment, the computer 1102 is connected to the LAN 1152 through a wire and/or wireless communication network interface or adaptor 1156. The adaptor 1156 can facilitate wire and/or wireless communications to the LAN 1152, which may also include a wireless access point disposed thereon for communicating with the wireless functionality of the adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wire and/or wireless device, is connected to the system bus 1108 via the input device interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi (or Wireless Fidelity) and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3 or Ethernet).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented graphical programming system, comprising:
a programming component for providing a programming environment in which a computational graph is generated and applied to a computing cluster; and
a graphical component for providing drag-and-drop functionality in the programming environment to create the computational graph.

2. The system of claim 1, wherein the graphical component presents computational elements related to distributed computing abstractions of a managed library.

3. The system of claim 2, wherein the computational elements represent built-in functions each having a specific signature.

4. The system of claim 3, wherein the graphical component presents a signature associated with a graph node in response to selection of the graph node in the computational graph.

5. The system of claim 1, wherein the graphical component allows entry and selection of a function, an argument for the function, and inputs.

6. The system of claim 1, wherein the graphical component presents a tailored view based on a selected node of the computational graph.

7. The system of claim 6, wherein the tailored view includes structure query language statement semantics.

8. The system of claim 1, wherein the graphical component presents multiple library functions of a node selected in the computational graph.

9. The system of claim 1, wherein the programming component compiles code associated with the computational graph for application to the computer cluster.

10. The system of claim 1, wherein the graphical component includes a user interface via which the drag-and-drop functionality, computational elements for creating the computational graph, creation state of the computational graph as presented on a canvas, code associated with nodes of the computational graph, and complied version of the computational graph, are exposed for interaction.

11. The system of claim 1, wherein the computational elements include one or more of SQL statements.

12. A computer-implemented method of developing a massively parallel application, comprising:
presenting computational elements in a graphical programming environment;
inserting a computational element into a graphing area as part of a generating a computational graph;
converting the computation element into a node of the computational graph; and
presenting code associated with the node.

13. The method of claim 12, further comprising compiling the computational graph into a computation application for execution on a parallel computing system.

14. The method of claim 12, wherein the computation elements include aggregate and join.

15. The method of claim 12, further comprising presenting SQL clauses associated with a SQL statement of the node when the node is selected.

16. The method of claim 12, further comprising presenting library functions associated with the node when the node is selected.

17. The method of claim 12, further comprising inserting multiple computational elements into the graphing area by drag-and-drop operations for computing an output based on multiple processes.

18. The method of claim 12, further comprising presenting methods and libraries that match a function associated with the node.

19. The method of claim 12, further comprising presenting a coding block for writing and entering code associated with the node.

20. A computer-implemented system, comprising:
computer-implemented means for presenting computational elements in a graphical programming environment;
computer-implemented means for inserting a computational element into a graphing area as part of a generating a computational graph;
computer-implemented means for converting the computation element into a node of the computational graph; and
computer-implemented means for presenting code associated with the node.
